(19) United States
(12) Patent Application Publication
(10) Pub. No.: US 2026/0121390 A1
(43) Pub. Date: Apr. 30, 2026

(54) TRANSPARENT ELECTRICALLY CONDUCTIVE LAYERS FOR FLUIDIC CAVITIES

(71) Applicant: ADEIA SEMICONDUCTOR BONDING TECHNOLOGIES INC., San Jose, CA (US)

(72) Inventor: Cyprian Emeka Uzoh, San Jose, CA (US)

(21) Appl. No.: 18/929,150

(22) Filed: Oct. 28, 2024

(51) Int. Cl. H02G 3/04; H01B 13/00

(52) U.S. Cl. CPC H02G 3/04; H01B 13/0036

(57) ABSTRACT

A structure includes an optically transparent first substrate having a first surface and at least one first layer including at least one electrically conductive and optically transparent first material. The structure further includes a second substrate having a second surface and at least one second layer including at least one electrically conductive second material. The second surface faces the first surface, and at least one of the first and second surfaces includes at least one recess. The structure further includes a fluid conduit between the first and second surfaces. The fluid conduit includes the at least one recess and is configured to allow a fluid flow therethrough. The at least one first layer and the at least one second layer are configured to apply an electric voltage and/or current to a fluid within at least a portion of the fluid conduit.

### BACKGROUND

### Field

The field relates to systems and methods for fabricating fluidic cavities with electrodes using wafer-to-wafer, die-to-die, and/or die-to-wafer hybrid bonding of semiconductor substrates.

### Description of the Related Art

Semiconductor elements, such as semiconductor wafers or integrated device dies, can be stacked and directly bonded to one another without an adhesive, thereby forming a bonded structure. Nonconductive (e.g., dielectric; semiconductor) surfaces can be made extremely smooth and treated to enhance direct, covalent bonding, even at room temperature and without application of pressure beyond contact. In some hybrid bonded structures, nonconductive field regions of the elements can be directly bonded to one another, and corresponding conductive contact structures can be directly bonded to one another.

For example, a semiconductor element can be mounted to a carrier, such as a package substrate, an interposer, a reconstituted wafer or element, a flat panel, a glass, etc. A semiconductor element can be stacked on top of the semiconductor element (e.g., a first integrated device die can be stacked on a second integrated device die). Each of the semiconductor elements can have conductive pads for mechanically and electrically bonding the semiconductor elements to one another with the conductive pads mechanically and electrically bonded to one another.

### SUMMARY

Certain implementations described herein provide a structure comprising an optically transparent first substrate comprising a first surface and at least one first layer on at least a portion of the first surface. The at least one first layer comprises at least one electrically conductive and optically transparent first material. The structure further comprises a second substrate comprising a second surface and at least one second layer on at least a portion of the second surface. The at least one second layer comprises at least one electrically conductive second material. The second surface faces the first surface, and at least one of the first and second surfaces comprises at least one recess. The structure further comprises a fluid conduit between the first and second surfaces. The fluid conduit comprises the at least one recess and is configured to allow a fluid flow therethrough. The at least one first layer and the at least one second layer are configured to apply an electric voltage and/or current to a fluid within at least a portion of the fluid conduit.

Certain implementations described herein provide a method comprising providing an optically transparent first substrate and forming a cavity at a first surface of the first substrate. The method further comprises forming an electrically conductive and optically transparent non-metallic first electrode on an inner wall of the cavity. The method further comprises providing a second substrate having an electrically conductive second electrode on a second surface of the second substrate. The method further comprises coupling the second substrate to the first substrate such that the second surface at least partially encloses the cavity to form a fluid conduit configured to allow a fluid to flow therethrough. The first electrode is electrically isolated from the second electrode.

Certain implementations described herein provide a structure comprising an optically transparent first substrate comprising a first surface and at least one first layer on at least a portion of the first surface. The at least one first layer comprises at least one electrically conductive and optically transparent first material. The structure further comprises a second substrate comprising a second surface and at least one second layer on at least a portion of the second surface. The at least one second layer comprises at least one electrically conductive second material. The second surface faces the first surface. The structure further comprises a third substrate comprising a third surface, a fourth surface facing opposite to the third surface, and a hole extending from the third surface to the fourth surface. The third substrate is between the first substrate and the second substrate with the third surface facing the first surface and the fourth surface facing the second surface. The structure further comprises a fluid conduit between the first and second surfaces. The fluid conduit comprises the hole and is configured to allow a fluid flow therethrough. The at least one first layer and the at least one second layer are configured to apply an electric voltage and/or current to a fluid within at least a portion of the fluid conduit.

Certain implementations described herein provide a method comprising providing an optically transparent first substrate having an electrically conductive and optically transparent non-metallic first electrode on a first surface of the first substrate. The method further comprises providing a second substrate having an electrically conductive second electrode on a second surface of the second substrate. The method further comprises providing a third substrate having a cavity extending from a third surface of the third substrate to a fourth surface of the third substrate, the fourth surface facing opposite to the third surface. The method further comprises coupling the first substrate to the third substrate and coupling the second substrate to the third substrate such that the first and second surfaces at least partially enclose the cavity to form a fluid conduit configured to allow a fluid to flow therethrough. The first electrode is electrically isolated from the second electrode.

Certain implementations described herein provide an apparatus comprising an optically transparent first substrate comprising a first surface and at least one first layer on at least a portion of the first surface. The at least one first layer comprises at least one electrically conductive and optically transparent first material. The apparatus further comprises a second substrate comprising a second surface and at least one second layer on at least a portion of the second surface. The at least one second layer comprises at least one electrically conductive second material, the second surface facing the first surface. At least one of the first and second surfaces comprises at least one cavity between the first and second surfaces, the cavity configured to allow a fluid flow therethrough. The at least one first layer and the at least one second layer are configured to apply an electric voltage and/or current to a fluid within at least a portion of the at least one cavity.

### BRIEF DESCRIPTION OF THE DRAWINGS

Specific implementations will now be described with reference to the following drawings, which are provided by way of example, and not limitation.

FIG. 1A is a schematic cross-sectional side view of two elements prior to bonding in accordance with certain implementations described herein.

FIG. 1B is a schematic cross-sectional side view of the two elements of FIG. 1A after bonding in accordance with certain implementations described herein.

FIGS. 2A-2F schematically illustrate cross-sectional views of various examples of a structure in accordance with certain implementations described herein.

FIGS. 3A-3C schematically illustrate perspective views of three example structures in accordance with certain implementations described herein.

FIGS. 4A-4D schematically illustrate cross-sectional views of four example structures in accordance with certain implementations described herein.

FIGS. 5A-5C schematically illustrate various example intermediate configurations for the first substrate obtained during an example method for fabricating an example structure in accordance with certain implementations described herein.

FIGS. 6A and 6B are flow diagrams of two examples of a method 400 for forming the example structure in accordance with certain implementations described herein.

FIG. 7 is a flow diagram of another example method for forming the example structure in accordance with certain implementations described herein.

### DETAILED DESCRIPTION

Various implementations disclosed herein relate to directly bonded structures in which two or more elements can be directly bonded to one another without an intervening adhesive. In some embodiments, direct bonding can involve bonding of a single material on one element and a single material on the other element, where the single materials on the different elements may or may not be the same. Direct bonding can also involve bonding of multiple materials on one element to multiple materials on the other element (e.g., hybrid bonding).

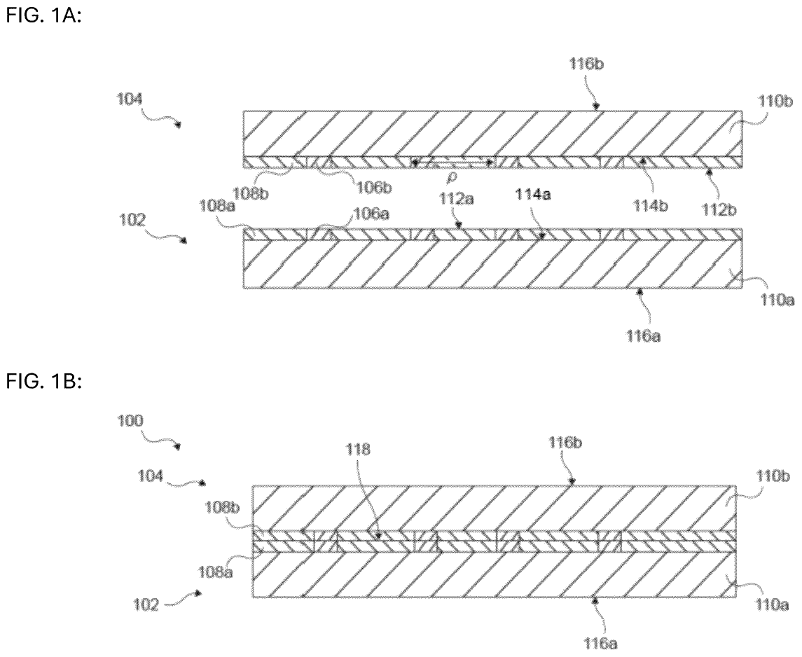

FIGS. 1A and 1B schematically illustrate cross-sectional side views of two elements 102, 104 prior to and after, respectively, a typical bonding process for forming a hybrid bonded structure 100 without an intervening adhesive (which may sometimes be referred to as a “direct hybrid bonded structure”). As used herein, the term “hybrid bonding” refers to a species of direct bonding in which there are both i) nonconductive features directly bonded to nonconductive features, and ii) conductive features directly bonded to conductive features. In the implementations disclosed herein, for example, the conductive features can comprise electrically conductive oxide material(s). In some implementations, the conductive features can serve as signal, power, or ground connections between two elements. In other implementations, at least some of the conductive features may be electrically isolated such that they do not serve as electrical connections between elements. As shown in FIGS. 1A and 1B, the bonded structure 100 can comprise a first element 102 and a second element 104 that are directly bonded to one another at a bond interface 118 without an intervening adhesive. The first and second elements 102, 104 can comprise microelectronic elements (e.g., semiconductor elements, including, for example, integrated device dies, wafers, passive devices, individual active devices such as power switches, etc.) and/or optical elements or devices (e.g., photodiodes; light emitting diodes (LEDs); quantum dot light emitting diodes (QLEDs); lasers; vertical-cavity surface-emitting lasers (VCSELs); transparency control pixels; liquid crystal pixels; adaptive optics; waveguides) that are stacked on or bonded to one another to form the bonded structure 100. For example, one or both of the first and second elements 102, 104 can comprise a thinned substrate or integrated device die having a thickness in a range of about 10 μm to 700 μm, in a range of about 10 μm to 300 μm, in a range of about 30 μm to 300 μm, or in a range of about 50 μm to 300 μm. Conductive features 106a (e.g., contact pads, exposed ends of vias (e.g., TSVs), or a through substrate electrodes) of the first element 102 can be electrically connected to corresponding conductive features 106b of the second element 104. In certain implementations, the conductive features 106a comprise an electrically conductive material that is optically transparent (e.g., indium tin oxide (ITO), indium-doped zinc oxide (IZO), tin oxide (SnO₂)) or optically semi-transparent (e.g., metal or polysilicon layer having a thickness less than 50 nanometers). Accordingly, as explained herein, the conductive features 106a can comprise conductive oxide materials in various implementations.

While FIGS. 1A and 1B schematically illustrate two elements 102, 104, any suitable number of elements can be stacked in the bonded structure 100 in accordance with certain implementations described herein. For example, a third element (not shown) can be stacked on the second element 104, a fourth element (not shown) can be stacked on the third element, and so forth. Additionally or alternatively, one or more additional elements (not shown) can be stacked laterally adjacent one another along the first element 102. In certain implementations, the laterally stacked additional element can be smaller than the second element 104 (e.g., the laterally stacked additional element can be two times smaller than the second element 104).

In certain implementations, the elements 102, 104 are directly bonded to one another without an adhesive. Bonding layers can be provided on front sides and/or back sides of the first and second elements 102, 104. For example, as schematically illustrated in FIGS. 1A and 1B, a first bonding layer 108a of the first element 102 can comprise a nonconductive field region of the first element 102 that includes a nonconductive or dielectric material (e.g., a dielectric material, such as silicon oxide, silicon nitride, silicon carbide, or an undoped semiconductor material, such as undoped silicon) and a second bonding layer 108b of the second element 104 can comprise a nonconductive field region of the second element 104 that includes a nonconductive or dielectric material (e.g., a dielectric material, such as silicon oxide/nitride/carbide, or an undoped semiconductor material, such as undoped silicon). The first and second bonding layers 108a, 108b can be disposed on respective front sides 114a, 114b of device portions 110a, 110b, such as semiconductor (e.g., silicon) portions, of the first and second elements 102, 104. Active devices or passive devices or both (e.g., electrical devices; optical devices) and/or circuitry can be patterned and/or otherwise disposed in or on the device portions 110a, 110b, disposed at or near the front sides 114a, 114b of the device portions 110a, 110b, and/or at or near opposite backsides 116a, 116b of the device portions 110a, 110b. In other embodiments, such as the embodiments disclosed hereinbelow, the field regions of the bonding layer may include conductive materials (e.g., ITO) that are patterned to be isolated from devices, such that they the field regions do not serve as electrical connections.

The first and second bonding layers 108a, 108b can be directly bonded to one another without an adhesive (e.g., using dielectric-to-dielectric bonding techniques, or conductor-to-conductor bonding techniques described in more detail hereinbelow). For example, non-conductive or dielectric-to-dielectric bonds may be formed without an adhesive using the direct bonding techniques disclosed at least in U.S. Pat. Nos. 9,564,414; 9,391,143; and 10,434,749, the entire contents of each of which are incorporated by reference herein in their entirety and for all purposes. Suitable dielectric bonding surface or materials for direct bonding include but are not limited to inorganic dielectrics, such as silicon oxide, silicon nitride, or silicon oxynitride, or can include carbon, such as silicon carbide, silicon oxycarbonitride, low K dielectric materials, SiCOH dielectrics, silicon carbonitride or diamond-like carbon or a material comprising a diamond surface. Such carbon-containing ceramic materials can be considered inorganic, despite the inclusion of carbon. In certain implementations, the bonding layers can include an inorganic bonding layer provided over one or more polymer materials, such as epoxy, resin or molding materials. In embodiments that include isolated conductive materials in the field regions for bonding, the isolation can be achieved by gaps or by dielectric materials, and in the latter case the dielectric materials can also be directly bonded in a hybrid bonding process.

In certain implementations, the device portions 110a, 110b can have significantly different coefficients of thermal expansion (CTEs) defining a heterogenous structure. The CTE difference between the device portions 110a, 110b, and particularly between bulk semiconductor (e.g., typically single crystal) portions of the device portions 110a, 110b can be greater than 5 ppm or greater than 10 ppm. For example, the CTE values for certain materials compatible with certain implementations described herein are in a range of 2 ppm to 10 ppm and the CTE difference between the device portions 110a, 110b can be in a range of 1 ppm to 10 ppm, 2 ppm to 10 ppm, or 5 ppm to 40 ppm. In certain implementations, one of the device portions 110a, 110b can comprise optoelectronic single crystal materials, including perovskite materials, that are useful for optical piezoelectric or pyroelectric applications, and the other of the device portions 110a, 110b can comprise a more conventional substrate material. For example, one of the device portions 110a, 110b can comprise lithium tantalate (LiTaO₃) or lithium niobate (LiNbO₃), and the other one of the device portions 110a, 110b can comprise silicon (Si), quartz, fused silica glass, sapphire, or a glass. In certain other implementations, one of the device portions 110a, 110b comprises a III-V single semiconductor material, such as gallium arsenide (GaAs) or gallium nitride (GaN), and the other one of the device portions 110a, 110b comprises a non-III-V semiconductor material, such as silicon (Si), or another materials with similar CTE, such as quartz, fused silica glass, sapphire, or a glass.

In certain implementations, hybrid bonds can be formed without an intervening adhesive. For example, bonding surfaces 112a, 112b of the nonconductive field regions of the bonding layers 108a, 108b can be polished to a high degree of smoothness (e.g., using chemical mechanical polishing (CMP)). The roughness of the polished surfaces 112a, 112b can be less than 30 Å rms. For example, the roughness of the polished surfaces 112a, 112b can be in a range of about 0.1 Å rms to 15 Å rms, 0.5 Å rms to 10 Å rms, or 1 Å rms to 5 Å rms. In other embodiments, as explained herein, one or both bonding surfaces 112a, 112b may comprise conductive oxides that are not be planarized, or may be planarized to a lesser degree. In such embodiments, the roughness of the unpolished surfaces 112a, 112b can be greater than 30 Å rms. The surfaces 112a, 112b can be cleaned and exposed to plasma and/or chemical etchants to activate the surfaces 112a, 112b. In certain implementations, the surfaces 112a, 112b can be terminated with a species after activation or during activation (e.g., during the plasma and/or etch processes). In some implementations, such as the conductive oxide bonding surfaces disclosed herein, one or both surfaces 112a, 112b may not be activated and/or terminated. Without being limited by theory, in certain implementations, the activation process can be performed to break chemical bonds at the surfaces 112a, 112b, and the termination process can provide additional chemical species at the surfaces 112a, 112b that improves the bonding energy during direct bonding. In certain implementations, the activation and termination are provided in the same step (e.g., a plasma to activate and terminate the surfaces 112a, 112b). In certain other implementations, the surfaces 112a, 112b are terminated in a separate treatment from the activation process to provide the additional species for direct bonding. In certain implementations, the terminating species can comprise nitrogen. For example, one or both of the surfaces 112a, 112b can be exposed to a nitrogen-containing plasma (see, e.g., U.S. Pat. No. 7,387,944). Further, in certain implementations, one or both of the surfaces 112a, 112b are exposed to fluorine. For example, there may be one or multiple fluorine peaks at or near a bond interface 118 between the first and second elements 102, 104. Thus, in the directly bonded structure 100, the bond interface 118 between two nonconductive materials (e.g., the first and second bonding layers 108a, 108b) can comprise a very smooth interface with higher nitrogen content and/or fluorine peaks at the bond interface 118 (see, e.g., U.S. Pat. No. 9,564,414). Additional examples of activation and/or termination treatments may be found throughout U.S. Pat. Nos. 9,564,414; 9,391,143; and 10,434,749, the entire contents of each of which are incorporated by reference herein in their entirety and for all purposes. The roughness of the polished surfaces 112a, 112b can be slightly rougher (e.g., about 1 Å rms to 30 Å rms, 3 Å rms to 20 Å rms, or possibly rougher) after an activation process.

In certain implementations, the conductive features 106a of the first element 102 are directly bonded to the corresponding conductive features 106b of the second element 104. For example, a hybrid bonding technique can be used to provide conductor-to-conductor direct bonds along the bond interface 118 that includes covalently direct bonded non-conductive-to-non-conductive (e.g., dielectric-to-dielectric) surfaces, prepared as described herein. In typical implementations that employ metal conductive features, the conductor-to-conductor (e.g., conductive feature 106a to conductive feature 106b) direct bonds and the dielectric-to-dielectric hybrid bonds can be formed using the direct bonding techniques disclosed at least in U.S. Pat. Nos. 9,716,033 and 9,852,988, the entire contents of each of which are incorporated by reference herein in their entirety and for all purposes. In hybrid bonding implementations described herein, conductive features are provided within the nonconductive field regions of the first and second bonding layers 108a, 108b, and both conductive and nonconductive features are prepared for direct bonding, such as by the planarization, activation and/or termination treatments described herein. Thus, the first and second bonding layers 108a, 108b prepared for direct bonding includes both conductive and nonconductive features.

For example, surfaces 112a, 112b of the nonconductive (e.g., dielectric) field regions (for example, inorganic dielectric surfaces) can be prepared and directly bonded to one another without an intervening adhesive as explained herein. Conductive contact features (e.g., conductive features 106a, 106b) can be at least partially surrounded by nonconductive (e.g., dielectric) field regions within the first and second bonding layers 108a, 108b and can directly bond to one another without an intervening adhesive. In certain implementations, the conductive features 106a, 106b can comprise discrete pads or traces at least partially embedded in the nonconductive material of the bonding layers 108a, 108b. In certain implementations, the conductive contact features comprise exposed contact surfaces of through substrate vias (e.g., through silicon vias (TSVs)). In some implementations, the conductive features 106a, 106b can be substantially flush with or protrude relative to the exterior surfaces of the nonconductive portions. In other implementations, the respective conductive features 106a, 106b can be recessed below the exterior (e.g., upper) surfaces (e.g., nonconductive bonding surfaces 112a, 112b) of the nonconductive portions of the first and second bonding layers 108a, 108b. For example, the recess can be less than 30 nm, less than 20 nm, less than 15 nm, or less than 10 nm, in a range of 2 nm to 20 nm, or in a range of 4 nm to 10 nm. In certain implementations, prior to direct bonding, the recesses in the opposing elements 102, 104 can be sized such that the total gap between opposing contact pads is less than 15 nm or less than 10 nm.

In hybrid bonding implementations, particularly where the conductive features 106a, 106b comprise metal materials, the first and second bonding layers 108a, 108b are directly bonded to one another without an adhesive at room temperature and, subsequently, the bonded structure 100 can be annealed. Upon annealing, the conductive features 106a, 106b can expand and contact one another to form a metal-to-metal direct bond. In such implementations, the materials of the conductive features 106a, 106b interdiffuse with one another during the annealing process. Beneficially, the use of Direct Bond Interconnect (DBI®) techniques commercially available from Adeia of San Jose, CA, can enable high density of conductive features 106a, 106b to be connected across the direct bond interface 118 (e.g., small or fine pitches for regular arrays). In certain implementations, the pitch of the conductive features 106a, 106b (e.g., conductive traces embedded in the bonding layer 108a, 108b of one of the bonded elements 102, 104) can be less than 100 microns or less than 10 microns or even less than 2 microns. For some applications, the ratio of the pitch of the conductive features 106a, 106b to one of the dimensions (e.g., a diameter) of the bonding pad is less than is less than 20, or less than 10, or less than 5, or less than 3 and sometimes desirably less than 2. In other applications, the width of the conductive traces embedded in the bonding layer 108a, 108b of one of the bonded elements 102, 104 is in a range between 0.1 micron to 20 microns (e.g., in a range of 0.3 micron to 3 microns). In typical implementations of hybrid bonded structures, the conductive features 106a, 106b and/or traces comprise copper or copper alloys, gold and gold alloys, nickel and nickel alloys, aluminum and aluminum alloys, although other metals and alloys may be suitable. For example, the conductive features, such as the conductive features 106a, 106b, can comprise fine-grain metal (e.g., a fine-grain copper). In the implementations disclosed herein, the conductive features 106a, 106b can comprise conductive oxide material(s) at least at the bond interface.

Thus, in direct bonding processes, the first element 102 can be directly bonded to the second element 104 without an intervening adhesive. In certain implementations, the first element 102 comprises a singulated element, such as a singulated integrated device die. In certain other implementations, the first element 102 comprises a carrier or substrate (e.g., a wafer) that includes a plurality (e.g., tens, hundreds, or more) of device regions that, when singulated, form a plurality of integrated device dies. Similarly, in certain implementations, the second element 104 comprises a singulated element, such as a singulated integrated device die. In certain other implementations, the second element 104 comprises a carrier or substrate (e.g., a wafer). Certain implementations disclosed herein can accordingly apply to wafer-to-wafer (W2W), die-to-die (D2D), or die-to-wafer (D2W), wafer to flat panel (W2FP), die to flat panel (D2FP), flat panel to flat panel (FP2FP) bonding processes. In wafer-to-wafer (W2W) processes, two or more wafers can be directly bonded to one another (e.g., hybrid bonded) and singulated using a suitable singulation process. After singulation, side edges of the singulated structure (e.g., the side edges of the two bonded elements 102, 104) can be substantially flush and can include markings indicative of the common singulation process for the bonded structure (e.g., saw markings if a saw singulation process is used).

As explained herein, the first and second elements 102, 104 can be directly bonded to one another without an adhesive, which is different from a deposition process and results in a structurally different interface compared to a deposition. In certain implementations, a width of the first element 102 in the bonded structure is similar to a width of the second element 104. In certain other implementations, a width of the first element 102 in the bonded structure 100 is different from a width of the second element 104. Similarly, the width or area of the larger of the first and second elements 102, 104 in the bonded structure can be at least 10% larger than the width or area of the smaller of the first and second elements 102, 104. The first and second elements 102, 104 can accordingly comprise non-deposited elements. Further, the directly bonded structures 100, unlike the deposited layers, can include a defect region along the bond interface 118 in which nanometer-scale voids (e.g., nanovoids) are present. The nanovoids can be formed due to activation of the bonding surfaces 112a, 112b (e.g., exposure to a plasma). As explained herein, the bond interface 118 can include concentration of materials from the activation and/or last chemical treatment processes. For example, in certain implementations that utilize a nitrogen plasma for activation, a nitrogen peak can be formed at the bond interface 118. The nitrogen peak can be detectable using secondary ion mass spectroscopy (SIMS) techniques. In certain implementations, for example, a nitrogen termination treatment (e.g., exposing the bonding surface to a nitrogen-containing plasma) can replace OH groups of a hydrolyzed (OH-terminated) surface with NH₂, NO, or NO₂ molecules, yielding a nitrogen-terminated surface. In certain implementations that utilize an oxygen plasma for activation, an oxygen peak can be formed at the bond interface 118. In certain implementations, the bond interface 118 can comprise silicon oxynitride, silicon oxycarbonitride, or silicon carbonitride. As explained herein, the direct bond can comprise a covalent bond, which is stronger than van Der Waals bonds. The bonding layers 108a, 108b can also comprise polished surfaces 112a, 112b that are planarized to a high degree of smoothness.

In implementations that utilize hybrid bonding techniques with metallic pads (e.g., copper pads), the metal-to-metal bonds between the conductive features 106a, 106b can be joined such that metal grains grow into each other across the bond interface 118. In certain implementations, the metal is or includes copper, which can have grains oriented along the <111> crystal plane for improved copper diffusion across the bond interface 118. In certain implementations, the conductive features 106a, 106b include nanotwinned copper grain structure, which can aid in merging the conductive features during anneal. The bond interface 118 can extend substantially entirely to at least a portion of the bonded conductive features 106a, 106b, such that there is substantially no gap between the nonconductive bonding layers 108a, 108b at or near the bonded conductive features 106a, 106b. In certain implementations, a barrier layer may be provided under and/or laterally surrounding the conductive features 106a, 106b (e.g., which may include copper). In some embodiments disclosed herein, the conductive features 106a, 106b can comprise conductive oxide material(s), with grains growing across the bond interface upon annealing. In certain other implementations, however, there may be no barrier layer under the conductive features 106a, 106b, for example, as described in U.S. Pat. No. 11,195,748, which is incorporated by reference herein in its entirety and for all purposes.

Beneficially, the use of the hybrid bonding techniques described herein can enable extremely fine pitch between adjacent conductive features 106a, 106b, and/or small pad sizes. For example, in certain implementations, the pitch p (e.g., the distance from edge-to-edge or center-to-center, as shown in FIG. 1A) between adjacent conductive features 106a (or between adjacent conductive features 106b) can be in a range of 0.2 micron to 50 microns, in a range of 0.75 micron to 25 microns, in a range of 1 micron to 25 microns, in a range of 1 micron to 10 microns, or in a range of 1 micron to 5 microns. Further, a major lateral dimension (e.g., a pad diameter) can be small as well, e.g., in a range of 0.1 micron to 30 microns, in a range of 0.25 micron to 5 microns, or in a range of 0.5 micron to 5 microns.

Certain implementations disclosed herein relate to fluidic devices (e.g., microfluidic chips; lab-on-a-chip devices; chip biosensors; microelectromechanical system (MEMS) reactors) (see, e.g., P. Pattanayak et al. “Microfluidic chips: recent advances, critical strategies in design, application and future perspectives,” Microfluidics and Nanofluidics, 25:99 (2021); D. Sarkar et al., “Microfluidic platform to study electric field based root targeting by a pathogenic zoospores,” IEEE MEMS 2022, Tokyo Japan, 9-13 January 2022, pp. 884-887 (2022); U.S. Pat. No. 11,367,652). Instead of, or in addition to, thin metal electrodes, the fluidic devices of certain implementations described herein can include electrodes comprising optically transparent or optically semi-transparent and electrically conductive materials (e.g., electrically conductive oxides; electrically conductive polymers) configured to apply electrical voltage and/or current signals to a fluid within a fluidic cavity or conduit. The fluidic devices can be fabricated using at least two substrates that are stacked on or bonded to one another to form a bonded structure. The electrically conductive materials on separate substrates can be planarized and the planarized surfaces of the substrates can be placed in contact with one another, as described herein, to form the bonded structures.

As used herein, the term “optically transparent” includes but is not limited to optically translucent, optically semi-transparent, and/or having an optical transmittance of at least 50% (e.g., at least 60%; at least 75%; at least 88%; greater than or equal to 95%) at optical wavelengths in a predetermined range. For example, the predetermined range for optically transparent components (e.g., elements; substrates; layers; devices; features) can be visible wavelengths (e.g., 390 nanometers to 750 nanometers; 400 nanometers to 700 nanometers), ultraviolet wavelengths (e.g., 100 nanometers to 400 nanometers), infrared wavelengths (e.g., 800 nanometers to 1 millimeter), and/or short-wave infrared (SWIR) wavelengths (e.g., 1400 nanometers to 3000 nanometers).

In addition to the use of the optically transparent and electrically conductive materials for electrodes, such materials can be used in the application of hybrid bonding in fluidic devices to reduce (e.g., minimize) the optically opaque contact areas while increasing (e.g., maximizing) the optically transparent areas. Certain implementations described herein utilize optically transparent and electrically conductive materials in hybrid bonded devices, in place of metal connectors. Certain such implementations can also include planarization of dielectric surfaces to prepare the substrate surfaces for bonding. Upon the surfaces of two substrates being put into contact with one another, the dielectric surface portions can directly bond to one another and the electrically conductive surface portions can bond to one another (e.g., without an intervening adhesive material) to form interconnects.

For example, the electrically conductive surface portions can comprise electrically conductive oxides (e.g., indium tin oxide or ITO) or nitrides. Certain such materials have the ability to self-bond at modest temperatures (e.g., in a range of 75° C. to 400° C.; in a range of 120° C. to 300° C.; in a range of 150° C. to 300° C.), and can be used to simplify processes for bonding (e.g., blanket wafer and hybrid bonding surfaces) by omitting one or more other processing steps (e.g., planarization and/or surface activation). For example, the electrically conductive oxide or nitride layers can be self-leveled if planarized before patterning. In conjunction with certain layout structures, such electrically conductive oxide or nitride layers can be used to bond multiple input/output components with a single material interface. For example, ITO can be used to bond two substrates without a surface activation step, and in certain implementations, without a surface planarization (e.g., chemical-mechanical polishing or CMP) step.

For another example, the electrically conductive surface portions can comprise electrically conductive polymers that bond to one another by solvent bonding (e.g., application of a solvent to soften the electrically conductive polymer material such that applied pressure results in polymer chain interdiffusion at the bonding junction, which can occur below the glass transition temperature of the electrically conductive polymer material), thermal bonding (e.g., heating the electrically conductive polymer material to a specific temperature to soften the electrically conductive polymer material such that applied pressure and cooling results in bonding upon solidification), and/or mixed interlayer polymer bonding (see, e.g., A. J. Moule et al., “Mixed interlayers at the interface between PEDOT:PSS and conjugated polymers provide charge transport control,” J. Mater. Chem. C, Vol. 3, pp. 2664-2676 (2015)). In certain implementations, the electrically conductive polymer interconnects provide high transparency, low range resistivity (e.g., 10⁻⁴ to 10⁻³ Ω-cm), and/or resilience to mechanical cracking.

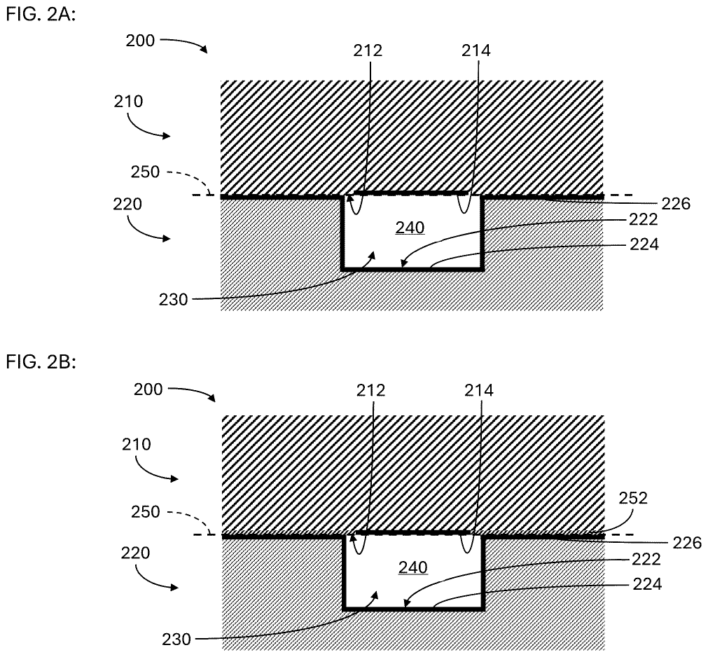

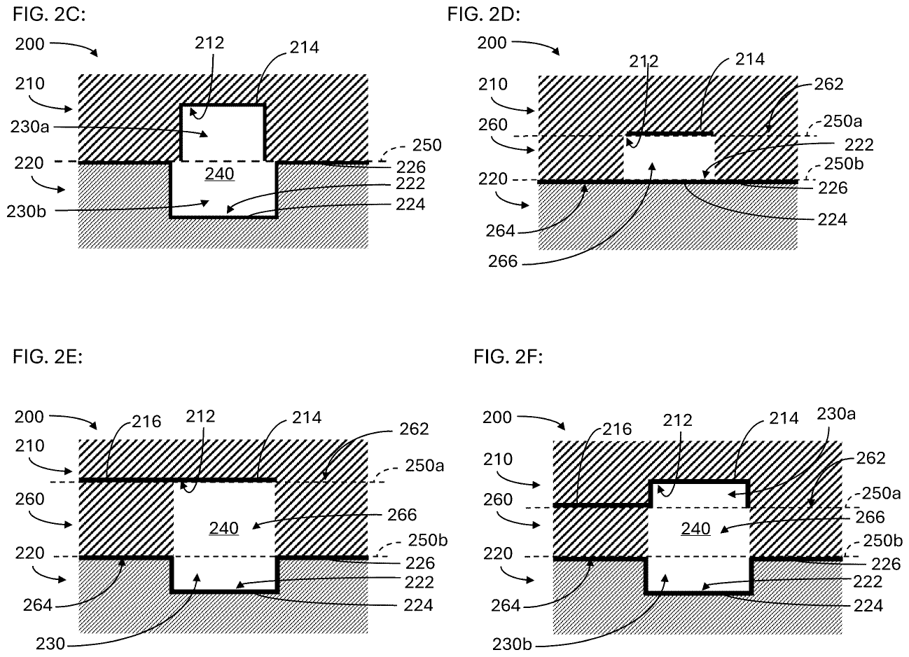

FIGS. 2A-2F schematically illustrate cross-sectional views of various examples of a structure 200 in accordance with certain implementations described herein. The structure 200 comprises an optically transparent first substrate 210 (e.g., first element 102) comprising a first surface 212 and at least one first layer 214 on at least a portion of the first surface 212. The at least one first layer 214 comprises at least one electrically conductive and optically transparent first material. The structure 200 further comprises a second substrate 220 (e.g., second element 104) comprising a second surface 222 and at least one second layer 224 on at least a portion of the second surface 222. The second surface 222 faces the first surface 212 and the structure 200 further comprises a fluid conduit 240 between the first surface 212 and the second surface 222 and configured to allow a fluid (not shown) to flow therethrough. The at least one first layer 214 and the at least one second layer 224 are configured to apply an electric voltage and/or current to a fluid within at least a portion of the fluid conduit 240.

In FIGS. 2A-2C, 2E, and 2F, at least one of the first surface 212 and the second surface 222 comprises at least one recess 230, and the fluid conduit 240 comprises the at least one recess 230. In FIGS. 2D, 2E, and 2F, the structure 200 comprises a third substrate 260 comprising a third surface 262, a fourth surface 264, and a hole 266 extending from the third surface 262 to the fourth surface 264. The third substrate 260 is between the first substrate 210 and the second substrate 220 with the third surface 262 facing the first surface 212 and the fourth surface 264 facing the second surface 222. The fluid conduit 240 comprises the hole 266.

In certain implementations, the first substrate 210 is optically transparent and electrically insulative (e.g., glass; quartz; silica; silicon oxide; polycarbonate; acrylic) and can have an area of at least 10 mm by 10 mm (e.g., 10 mm by 50 mm; 20 mm by 50 mm). The at least one first layer 214 can comprise at least one electrically conductive and optically transparent first material. For example, the first material can comprise an electrically conductive oxide (e.g., indium tin oxide; zinc oxide) and/or an electrically conductive polymer, examples of which include but are not limited to: intrinsically electrically conductive polymer selected from the group consisting of: polyacetylene (PA); polyaniline (PANI); poly[3,4-(ethylenedioxy)thiophene] (PEDOT); PEDOT:polystyrene-sulphonate (PEDOT:PSS); polypyrrole (PPy); polythiophene (PT); poly(o-phenylene-diamine) (PoPDA). In certain implementations, the resistivity of the electrically conductive polymer is in a range of 1×10⁻⁴ Ω-cm to 2.5 Ω-cm (e.g., 1.1×10⁻⁴ Ω-cm to 1×10⁻¹ Ω-cm; 1.3×10⁻⁴ Ω-cm to 1×10⁻¹ Ω-cm; in a range of 1.6×10⁻⁴ Ω-cm to 3.3×10⁻² Ω-cm; in a range of 2.2×10⁻⁴ Ω-cm to 5×10⁻³ Ω-cm). In certain implementations, the optical transmission of the first material within the wavelength range of interest is greater than 40% (e.g., greater than 60%; greater than 80%). Both the first substrate 210 and the at least one first layer 214 can have an optical transmittance greater than 40% (e.g., greater than 60%; greater than 80%).

In certain implementations, the at least one first layer 214 further comprises an optically transparent metal layer (e.g., having a thickness less than 50 nanometers and comprising at least one of: titanium nitride, gold, and platinum). The at least one first layer 214 with the metal layer can have an electrical resistivity lower than 10⁻⁴ Ω-cm.

In certain implementations, the second substrate 220 is electrically insulative (e.g., inorganic dielectric material; semiconductor oxide; semiconductor nitride; silicon oxide (SiO₂); silicon nitride (SiNₓ, Si₃N₄); silicon oxycarbonitride (SiOₓN_{y}C_{z}); ceramic; polycarbonate; acrylic; glass; quartz; silica; silicon oxide) and can have an area of at least 10 mm by 10 mm (e.g., 10 mm by 50 mm; 20 mm by 50 mm). In certain implementations, the second substrate 220 is optically transparent, while in certain other implementations, the second substrate 220 is optically opaque. The first and second substrates 210,220 can comprise the same electrically insulative material as one another or the first and second substrates 210,220 can comprise different electrically insulative materials from one another (e.g., materials having different elemental constituents and/or different stoichiometries).

In certain implementations, the at least one second layer 224 comprises an electrically conductive and optically opaque material (e.g., metallic material; aluminum; gold; copper; tungsten; cobalt). For example, the at least one second layer 224 can comprise an optically reflecting material (e.g., aluminum; gold) and can be configured to reflect light impinging the at least one second layer 224 from the fluid conduit 240 (e.g., light that has propagated through the first substrate 210, the at least one first layer 214, and the fluid within the fluid conduit 240; light that has been generated within the fluid conduit 240) back towards the fluid conduit 240 (e.g., such that the reflected light propagates through the fluid within the fluid conduit 240, the at least one first layer 214, and through the first substrate 210).

In certain other implementations in which the second substrate 220 is optically transparent, the at least one second layer 224 can comprise at least one electrically conductive and optically transparent second material. For example, the second material can comprise a non-metallic and electrically conductive oxide (e.g., indium tin oxide; zinc oxide) and/or a non-metallic and electrically conductive polymer, examples of which include but are not limited to: intrinsically electrically conductive polymer selected from the group consisting of: polyacetylene (PA); polyaniline (PANI); poly[3,4-(ethylenedioxy)thiophene] (PEDOT); PEDOT:polystyrene-sulphonate (PEDOT:PSS); polypyrrole (PPy); polythiophene (PT); poly(o-phenylene-diamine) (PoPDA). In certain implementations, the at least one second layer 224 further comprises an optically transparent metal layer (e.g., having a thickness less than 50 nanometers and comprising at least one of: titanium nitride, gold, and platinum). Both the second substrate 220 and the at least one second layer 224 can have an optical transmittance greater than 50%. The at least one second layer 224 can also have an electrical resistivity lower than 10⁻⁴ ohm·cm. The at least one electrically conductive and optically transparent first material and the at least one electrically conductive second material can be the same as one another or can be different from one another (e.g., having different elemental constituents and/or different stoichiometries).

In certain implementations, the first substrate 210 and/or the second substrate 220 comprises at least one device (not shown) that can be optically transparent (e.g., optoelectronic device; optoelectronic element; electro-optical element; solar cell) or can be optically non-transparent (e.g., opaque). The at least one device can comprise one or more electrical conduits 216 (e.g., external electrical contact) in electrical communication with the at least one first layer 214. For example, the one or more electrical conduits 216 can be on the first surface 212 of the first substrate 210. Similarly, the at least one device can comprise one or more electrical conduits 226 (e.g., external electrical conduits) in electrical communication with the at least one second layer 224. The one or more electrical conduits 216 and the one or more electrical conduits 226 can be displaced from one another (e.g., in different cross-sectional planes) such that the one or more electrical conduits 216 are electrically isolated from the one or more electrical conduits 226 (e.g., the one or more electrical conduits 216 are not seen in the cross-sectional views of FIGS. 2A-2D, while the one or more electrical conduits 226 are seen in the cross-sectional views of FIGS. 2A-2D). While FIGS. 2E and 2F show the one or more electrical conduits 216 extending from a single side of the first substrate 210 to the at least one first layer 214 and the one or more electrical conduits 226 extending from two sides of the second substrate 220 to the at least one second layer 224, certain other implementations have the one or more electrical conduits 216 extending from two sides of the first substrate 210 and/or the one or more electrical conduits 226 extending from a single side of the second substrate 220.

Example materials for the electrical conduits 216,226 include but are not limited to copper or copper alloys, although other metals and alloys may be suitable. In certain implementations, the first substrate 210 comprises at least one first device and at least one electrical contact (e.g., a large lateral area contact on a backside 116a of the corresponding device portion 110a) in electrical communication with the at least one device and/or the second substrate 220 comprises at least one second device and at least one electrical contact (e.g., on a backside 116b of the corresponding device portion 110b) in electrical communication with the at least one second device. The at least one electrical contact can be configured to transmit electrical signals to and/or from the first and/or second devices. In certain implementations, at least one of the electrical contacts comprises an electro-optical (EO) contact comprising a transparent and electrically conductive material (e.g., an electrically conductive non-metallic material as disclosed herein) that is in electrical and optical communication with the at least one first device and/or the at least one second device to transmit electrical and optical signals to and/or from the first and/or second devices.

In certain implementations, as schematically illustrated by FIGS. 2A-2C, 2E, and 2F, one of the first and second surfaces 212,222 comprises the at least one recess 230 (e.g., having a depth of less than 3 mm). For example, as shown in FIGS. 2A-2B, the second surface 222 comprises the at least one recess 230 (e.g., formed by etching, compressing, or stamping a portion of the second surface 222) and the first surface 212 does not comprise a recess 230. For another example, as shown in FIGS. 2C and 2F, the first surface 212 comprises a first recess 230a and the second surface 222 comprises a second recess 230b, the second recess 230b aligned with the first recess 230a such that the fluid conduit 240 includes both the first and second recesses 230a, b.

In certain implementations, as shown in FIGS. 2A-2F, at least a portion of the at least one first layer 214 and/or the at least one second layer 224 at least partially bounds the fluid conduit 240. For example, the portion of the at least one first layer 214 and/or the at least one second layer 224 can be on an inner surface of the fluid conduit 240 and the fluid within the fluid conduit 240 can contact the portion of the at least one first layer 214 and/or the at least one second layer 224. In certain implementations in which the fluid within the fluid conduit 240 is chemically reactive with a material (e.g., sub-layer) of the at least one first layer 214 and/or of the at least one second layer 224, the at least one first layer 214 and/or the at least one second layer 224 can comprise a protective material (e.g., sub-layer) at least partially bounding the fluid conduit 240 and that is less chemically reactive (e.g., chemically inert) to the fluid than is the chemically reactive material.

In certain implementations, the second substrate 220 is affixed (e.g., directly bonded; hybrid bonded) to the first substrate 210 at a bonding interface 250. In certain implementations, the at least one first layer 214 and/or the at least one second layer 224 affix the first and second surfaces 212,222 to one another. For example (see, e.g., FIGS. 2A and 2C), a portion of the at least one second layer 224 is sandwiched between the first and second surfaces 212,222 and affixes the first and second surfaces 212,222 to one another at the bonding interface 250 without an intervening adhesive between the first and second surfaces 212,222. For another example (see, e.g., FIG. 2B), the structure 200 further comprises a bonding layer 252 between the first surface 212 and the second surface 222 (e.g., having a thickness less than 3 microns or less than 1 micron) and configured to bond the first and second substrates 210,220 to one another (e.g., affixing the first and second surfaces 212,222 to one another at the bonding interface 250). Example materials of the bonding layer 252 include but are not limited to: an adhesive material; an inorganic dielectric material (e.g., SiN; SiOₓN_{y}; SiC). For example, for a second substrate 220 comprising glass (e.g., sodalime glass; SiO) or a polymer material coated with glass, the at least one second layer 224 can comprise ITO and an inorganic dielectric material over the ITO, the inorganic dielectric material bonding the first and second substrates 210,220 to one another. In certain implementations in which the bonding layer 252 is configured to be exposed to the fluid within the fluid conduit 240, the material of the bolding layer 252 is chemically inert to the fluid.

In certain implementations, as schematically illustrated by FIGS. 2D-2F, the structure 200 further comprises a third substrate 260 comprising a third surface 262, a fourth surface 264 facing opposite to the third surface 262, and a hole 266 extending from the third surface 262 to the fourth surface 264 (e.g., having a width in a range of 100 microns to 3 mm). In certain implementations, the third substrate 260 is electrically insulative (e.g., e.g., inorganic dielectric material; semiconductor oxide; semiconductor nitride; silicon oxide (SiO₂); silicon nitride (SiNₓ, Si₃N₄); silicon oxycarbonitride (SiOₓN_{y}C_{z}); ceramic; glass; quartz; silica; silicon oxide; polycarbonate; acrylic) and can be optically transparent or optically opaque. The third substrate 260 can comprise the same electrically insulative material as one or both of the first and second substrates 210,220 or the third substrate 260 can comprise a different electrically insulative material from one or both of the first and second substrates 210,220. In certain implementations, the inner surface of the hole 266 comprises one or more electrically conductive layers (not shown) that are electrically isolated from the at least one first layer 214 and the at least one second layer 224 and that can be used as additional electrodes to apply electrical voltages and/or currents to the fluid within the fluid conduit 240.

In certain implementations, as shown in FIGS. 2D-2F, the third substrate 260 is between the first substrate 210 and the second substrate 220 with the third surface 262 facing the first surface 212, the fourth surface 264 facing the second surface 222. As shown in FIG. 2D in which neither the first surface 212 nor the second surface 222 comprising at least one recess 230, the fluid conduit 240 includes the hole 266, and the first surface 212 is bonded to the third surface 262 and the second surface 222 is bonded to the fourth surface 264. As shown in FIGS. 2E and 2F, the hole 266 can be aligned with the at least one recess 230 such that the fluid conduit 240 includes the hole 266 and the at least one recess 230. For example, in FIG. 2E, the first surface 212 of the first substrate 210 does not comprise at least one recess 230, and the second surface 222 of the second substrate 220 does comprise at least one recess 230. The first surface 212 is bonded to the third surface 262 at a bonding interface 250a, the second surface 222 is bonded to a portion of the fourth surface 264 outside the recess 230 at a bonding interface 250b, and the hole 266 is aligned with the recess 230. For another example, in FIG. 2F, the first surface 212 of the first substrate 210 comprises a first recess 230a, the second surface 222 of the second substrate 220 comprises a second recess 230b, the first surface 212 is bonded to a portion of the third surface 262 outside the first recess 230a at a bonding interface 250a, the second surface 222 is bonded to a portion of the fourth surface 264 outside the second recess 230b at a bonding interface 250b, and the hole 266 is aligned with the first and second recesses 230a, b. In certain implementations (see, e.g., FIG. 2E), the first substrate 210 and the second substrate 220 does not comprise a recess, the fluid conduit 240 is formed in a portion of the third substrate 260, and the at least one first layer 214 and/or the at least one second layer 224 are on opposing side of the fluid conduit 240 or hole 266. In certain implementations, the interior wall of the third substrate 260 exposed to the fluid conduit 240 and can be coated with a thin material (not shown) comprising a catalytic layer (e.g., platinum group and non platinum group metals). The catalytic layer can comprise a nanoparticle material. In certain implementation, a portion of the at least one first layer 214 and/or the at least one second layer 224 can comprise a catalytic layer.

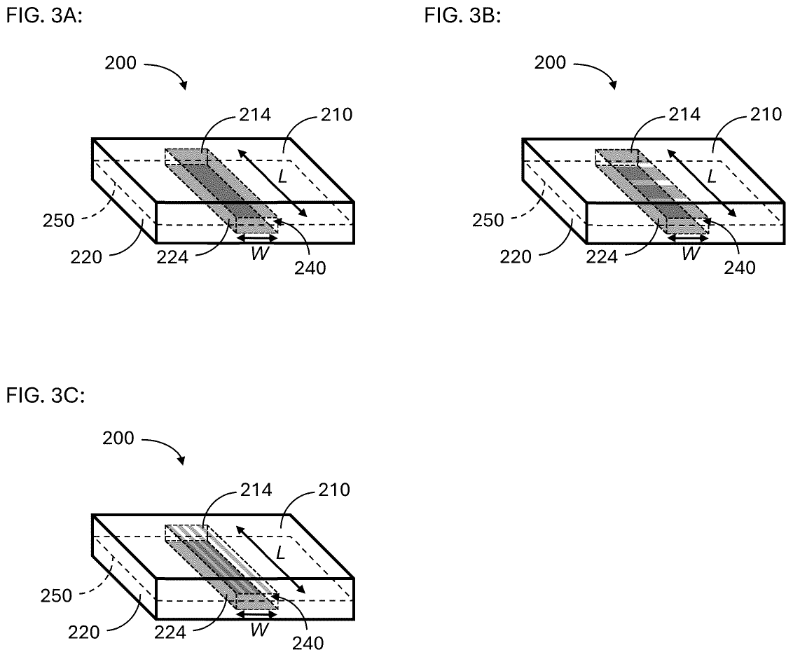

FIGS. 3A-3C schematically illustrate perspective views of three example structures 200 in accordance with certain implementations described herein. In each of FIGS. 3A-3C, the at least one second layer 224 is continuous along a length L of the fluid conduit 240 and a width W of the fluid conduit 240 (e.g., in a range of 100 microns to 2 millimeters). In certain implementations, (see, e.g., FIG. 3A), the at least one first layer 214 is also continuous along the length L of the fluid conduit 240 and the width W of the fluid conduit 240. For example, the at least one first layer 214 and the at least one second layer 224 can be optically transparent. In certain other implementations, the at least one first layer 214 is discontinuous along the length L of the fluid conduit 240 and the width W of the fluid conduit 240. For example, as shown in FIG. 3B, the at least one first layer 214 comprises a plurality of regions separated from one another, each region having the width W and having a length less than the length L (e.g., each region having less than 20% of the length of the fluid conduit 240). Certain such implementations can apply different voltage and/or current signals at different locations along the length L of the fluid conduit 240. For another example, as shown in FIG. 3C, the at least one first layer 214 comprises a plurality of regions separated from one another, each region having the length L and having a width less than the width W (e.g., each region having less than 20% of the length of the fluid conduit 240). Certain such implementations can apply different voltage and/or current signals at different locations along the width W of the fluid conduit 240. In FIGS. 3B and 3C, the at least one first layer 214 can be optically opaque and the discontinuities between the regions can be optically transparent, and the at least one second layer 224 can be optically transparent or optically opaque. Other configurations of the at least one first layer 214 and the at least one second layer 224 are also compatible with certain implementations described herein.

In certain implementations, the structure 200 further comprises a first light source 310 configured to generate a first optical beam 312 and a detector 320 configured to receive a portion of the first optical beam 312 after the portion of the first optical beam 312 propagates through the fluid conduit 240 (e.g., the transmitted portion of the first optical beam 312). The first light source 310 can comprise at least one light-emitting device (e.g., light-emitting diode; lamp; laser) and the first optical beam 312 can comprise infrared light, visible light, and/or ultraviolet light, and can be monochromatic or polychromatic. The detector 320 can comprise at least one light sensor (e.g., photodiode; photoresistor; phototransistor; photovoltaic cell). In certain implementations, the first light source 310 and/or the detector 320 is mechanically coupled to the first substrate 210 and/or the second substrate 220, while in certain other implementations, the first light source 310 and/or the detector 320 is spaced from the first substrate 210 and/or the second substrate 220. The first light source 310 and the detector 320 can be in operative communication with control circuitry (e.g., computer; processor) to generate information regarding the optical transmittance of the fluid within the fluid conduit 240 as a function of wavelength of the first optical beam 312.

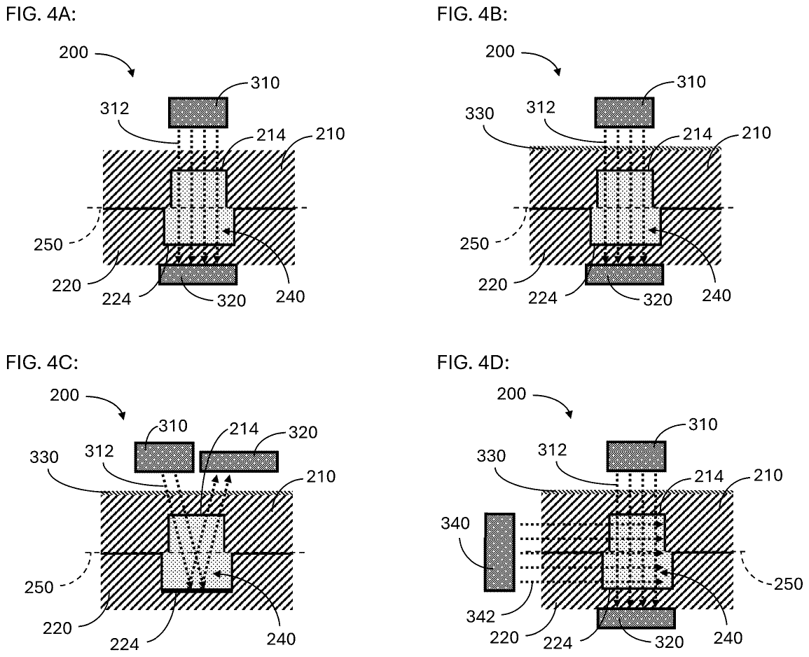

FIGS. 4A-4D schematically illustrate cross-sectional views of four example structures 200 in accordance with certain implementations described herein. As shown in FIGS. 4A and 4B, the first light source 310 and the detector 320 are on opposite sides of the fluid conduit 240 from one another, such that at least a portion of the first optical beam 312 propagates through the first substrate 210, through the at least one first layer 214, through the fluid conduit 240 (e.g., through fluid within the fluid conduit 240), through the at least one second layer 224, through the second substrate 220, to the detector 320. As shown in FIG. 4C, the first light source 310 and the detector 320 are on the same side of the fluid conduit 240 as one another and the at least one second layer 224 comprises an optically reflective material, such that at least a portion of the first optical beam 312 propagates through the first substrate 210, through the at least one first layer 214, through the fluid conduit 240 (e.g., through fluid within the fluid conduit 240), and is reflected by the at least one second layer 224. At least a portion of the reflected portion of the first optical beam 312 propagates back through the fluid conduit 240 (e.g., through the fluid within the fluid conduit 240), through the at least one first layer 214, and through the first substrate 210, to the detector 320.

In certain implementations, the structure 200 further comprises a second light source 340 configured to generate a second optical beam 342 configured to propagate through the first substrate 210 and/or the second substrate 220 to the fluid conduit 240. The second light source 340 can comprise at least one light-emitting device (e.g., light-emitting diode; lamp; laser) and the second optical beam 342 can comprise infrared light, visible light, and/or ultraviolet light, and can be monochromatic or polychromatic. The second optical beam 342 (e.g., pump or reactive beam) can be configured to excite at least some of the molecules of the fluid within the fluid conduit 240 (e.g., to initiate electronic or bonding state transitions of at least some of the molecules) and the portion of the first optical beam 312 (e.g., probe or sampling beam) that propagates through the fluid within the fluid conduit 240 and received by the detector 320 can be configured to include information regarding the excited molecules of the fluid. For example, as shown in FIG. 4D, the second optical beam 342 can propagate and enter the fluid conduit 240 from a side of the first and/or second substrates 210,220 (e.g., along a direction substantially perpendicular to the propagation direction of the first optical beam 312). Other orientations of the first optical beam 312 and the second optical beam 342 (e.g., an acute non-zero angle between the first and second optical beams 312,342; the first and second optical beams 312,342 substantially parallel to one another) are also compatible with certain implementations described herein.

In certain implementations, at least one of the first and second substrates 210,220 comprises an anti-reflection layer 330 between the first light source 310 and the detector 320. The anti-reflection layer 330 (e.g., magnesium fluoride, titanium nitride, silicon oxide, titanium oxide, aluminum oxide) can have a thickness in a range of less than 500 nm (e.g., less than 100 nm) and can be formed by evaporation or sputtering. For example, as shown in FIGS. 4B-4D, the anti-reflection layer 330 is on an outer surface of the first substrate 210 between the first light source 310 and the at least one first layer 214. Anti-reflection layers 330 in other locations are also compatible with certain implementations described herein (e.g., on an outer surface of the second substrate 220 between the at least one second layer 224 and the detector 320; as part of the at least one first layer 214; as part of the at least one second layer 224; on an outer surface of the first and/or second substrates 210,220 between the second light source 340 and the fluid conduit 240).

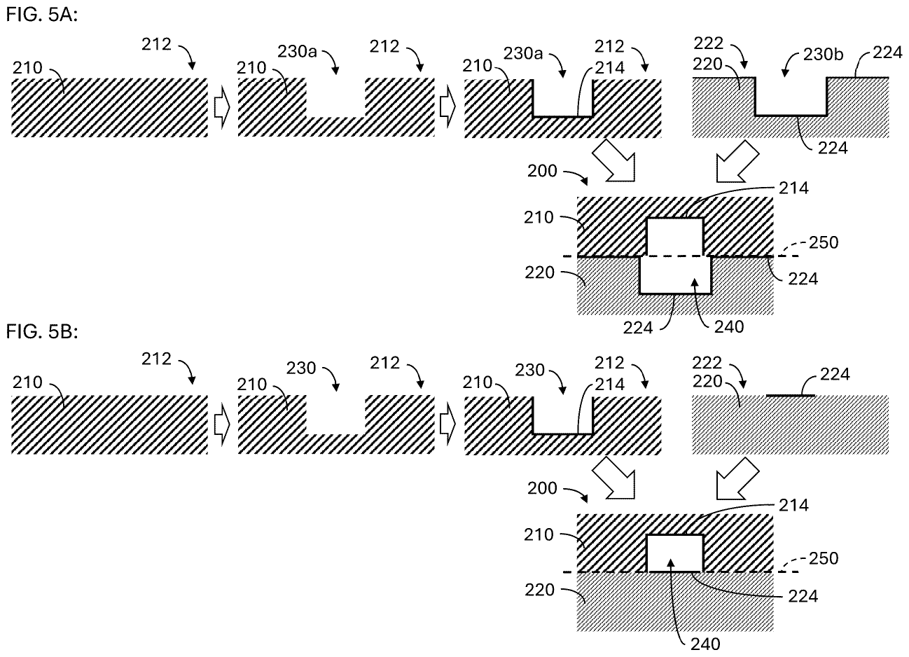

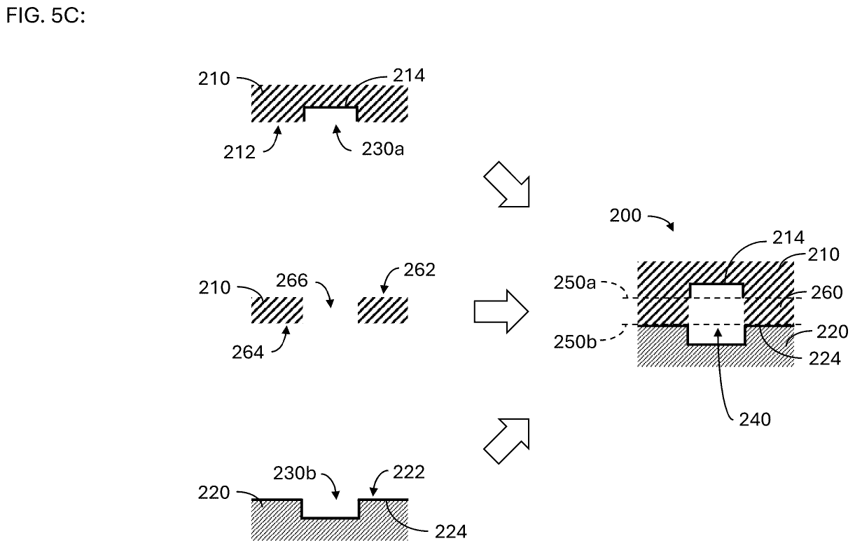

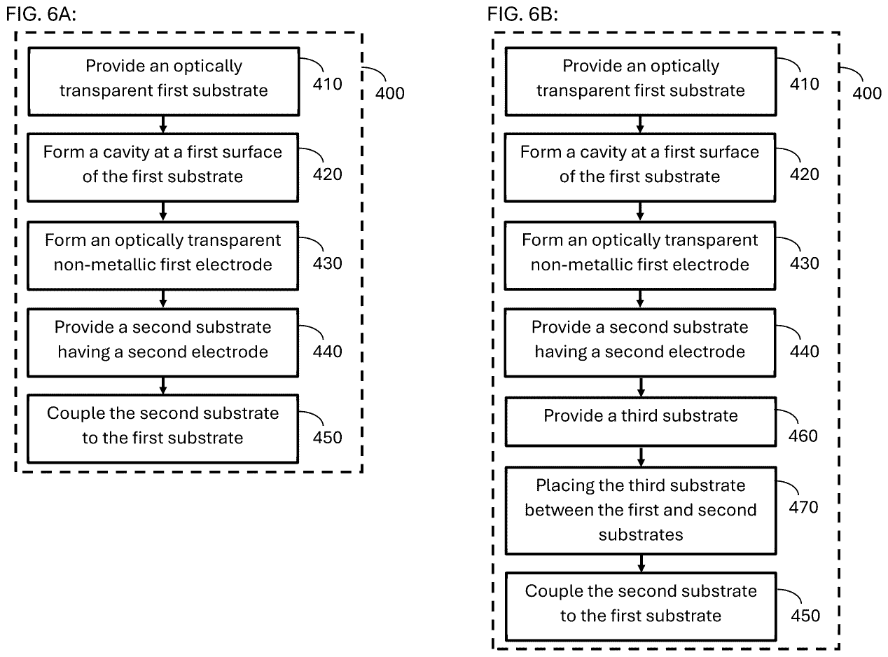

FIGS. 5A-5C schematically illustrate various example intermediate configurations for the first substrate 210 obtained during an example method 400 for fabricating an example structure 200 in accordance with certain implementations described herein. FIGS. 6A-6B are flow diagrams of two examples of a method 400 for forming the example structure 200 in accordance with certain implementations described herein. While FIGS. 5A-5B schematically illustrate intermediate configurations corresponding to providing the first substrate 210, providing the second substrate 220 can also be performed in a similar manner, resulting in similar intermediate configurations of the second substrate 220 as those shown in FIGS. 5A-5B.

In an operational block 410, the method 400 comprises providing an optically transparent first substrate 210 (e.g., first element 102). For example, the first substrate 210 can comprise an optically transparent and electrically insulative material (e.g., glass; quartz; silica; silicon oxide; polycarbonate; acrylic).

In an operational block 420, the method 400 further comprises forming a cavity (e.g., recess 230) at a first surface 212 of the first substrate 210. For example, while FIGS. 5A and 5B schematically show that the cavity can be formed by etching a portion of the first surface 212, other techniques for forming the cavity are also compatible with certain implementations described herein, including but not limited to depositing (e.g., evaporating; sputtering; 3D printing) additional material onto portions of the first surface 212 to surround the cavity or compressing (e.g., stamping) a portion of the first surface 212.

In an operational block 430, the method 400 further comprises forming an electrically conductive and optically transparent non-metallic first electrode (e.g., first layer 214) on an inner wall of the cavity. For example, the first electrode can comprise an electrically conductive polymer and/or an electrically conductive oxide. Forming the first electrode can comprise depositing an electrically conductive and optically transparent non-metallic material over a portion of the first surface 212 (e.g., on the inner walls of the cavity). The first electrode can be in electrical communication with an electrical conduit (not shown) configured to provide electrical voltage and/or current signals to the first electrode.

In an operational block 440, the method 400 further comprises providing a second substrate 220 (e.g., second element 104) having an electrically conductive second electrode (e.g., second layer 224) on a second surface 222 of the second substrate 220. In certain implementations, the second substrate 220 and/or the second electrode is optically opaque, while in certain other implementations, the second substrate 220 and/or the second electrode is optically transparent. For example, the second substrate 220 can comprise an optically transparent and electrically insulative material (e.g., glass; quartz; silica; silicon oxide; polycarbonate; acrylic) and the second electrode can comprise an electrically conductive polymer and/or an electrically conductive oxide. The second electrode can be in electrical communication with an electrical conduit (not shown) configured to provide electrical voltage and/or current signals to the second electrode.

In certain implementations, providing the second substrate 220 comprises forming (e.g., depositing; evaporating; sputtering; 3D printing) the second electrode on the second surface 222, while in certain other implementations, providing the second substrate 220 comprises forming a second cavity (e.g., recess 230b) at the second surface 222 and forming the second electrode on an inner wall of the second cavity. Forming the second electrode on the second surface 222 can use the same techniques as are described herein for forming the first electrode on the inner wall of the cavity and forming the second cavity on the second surface 222 can use the same techniques as are described herein for forming the cavity at the first surface 212. In certain implementations, one of the substrates 210,220 can not comprise cavity and the first or second electrode can be formed on a portion of the surface of the substrate without a cavity. The first electrode and the second electrode can face opposite to one another (e.g., serving as an electrode and a counter electrode with a cavity therebetween.)

In an operational block 450, the method 400 further comprises coupling (e.g., bonding) the second substrate 220 to the first substrate 210 such that the second surface 222 at least partially encloses the cavity to form a fluid conduit 240 configured to allow a fluid to flow therethrough. The first electrode is electrically isolated from the second electrode (e.g., the first electrode is spaced from the second electrode by a distance in a range of 50 microns to 500 microns). For example, coupling the second substrate 220 to the first substrate 210 can comprise using at least a portion of the first electrode and/or at least a portion of the second electrode as a bonding interface 250 between the first and second substrates 210,220. For another example, coupling the second substrate 220 to the first substrate 210 can comprise placing an inorganic dielectric material between the first and second substrates 210,220 (e.g., deposited, evaporated, or sputtered onto the first surface 212 and/or the second surface 222) and using the inorganic dielectric material as a bonding interface between the first and second substrates 210,220. The inorganic dielectric material can comprise a planarized bonding surface with portions of one or more electrical conduits 216, for example, contacting the first and second electrodes.

In certain implementations, coupling the second substrate 220 to the first substrate 210 is performed without using an adhesive material as a bonding interface between the first and second substrates 210,220. For example, the second substrate 220 can be directly bonded or hybrid bonded to the first substrate 210. In certain implementations, coupling the second substrate 220 to the first substrate 210 comprises, for at least one of the first substrate 210 and the second substrate 220, activating the first surface 212 and/or the second surface 222 (e.g., exposing the surface to plasma and/or chemical etchants). The activation can be performed prior to hybrid bonding the first substrate 210 and the second substrate 220 with one another. In certain implementations in which the first electrode and/or the second electrode comprises conductive polymer material that facilitates the coupling, coupling the second substrate 220 to the first substrate 210 comprises annealing the structure at a temperature higher than the room temperature (e.g., at a temperature in a range of 90° C. to 200° C., such as 110° C.) for an annealing time (e.g., in a range of 10 minutes to 60 minutes) to cause the conductive polymer material to expand and to bond the first and second surfaces 212,222 to one another.

In certain implementations, as shown in FIG. 6B, in an operational block 460, the method 400 further comprises providing a third substrate 260 comprising a third surface 262, a fourth surface 264 facing opposite to the third surface 262, and a hole 266 extending from the third surface 262 to the fourth surface 264. For example, the hole 266 can be etched through the third substrate 260. In certain implementations, the first and second substrates 210,220 can not comprise a cavity and the fluid conduit 240 can be disposed within the hole 266 of the third substrate 260, with the first electrode on at least a first surface 212 facing the second electrode (e.g., counter electrode) on at least a second surface 222. In an operational block 470, the method 400 further comprises placing the third substrate 260 between the first substrate 210 and the second substrate 220 with the third surface 262 facing the first surface 212, the fourth surface 264 facing the second surface 222, and the hole 266 aligned with the at least one recess 230 such that the fluid conduit 240 includes the hole 266.

In certain such implementations, coupling the second substrate 220 to the first substrate 210 in the operational block 450 can comprise coupling the second substrate 220 to the third substrate 260 (e.g., coupling the second surface 222 to the fourth surface 264) and coupling the first substrate 210 to the third substrate 260 (e.g., coupling the first surface 212 to the third surface 262) with the hole 266 aligned with the cavity (e.g., the at least one recess 230). For example, at least a portion of the first electrode can be used as a bonding interface between the third substrate 260 and the first substrate 210 and/or at least a portion of the second electrode can be used as a bonding interface between the third substrate 260 and the second substrate 220. For another example, an inorganic dielectric material can be placed between the third substrate 260 and the first and/or second substrates 210,220 and the inorganic dielectric material can be as a bonding interface between the third substrate 260 and the first and/or second substrates 210,220. In certain implementations, coupling the second substrate 220 to the first substrate 210 is performed without using an adhesive material as a bonding interface between the third substrate 260 and the first and/or second substrates 210,220. For example, direct bonding of the third substrate 260 to the first substrate 210 and/or direct bonding of the third substrate 260 to the second substrate 220 can be used. For another example, hybrid bonding of the third substrate 260 to the first substrate 210 and/or hybrid bonding of the third substrate 260 to the second substrate 220 can be used.

In certain implementations, the bonded structures 200 can be coated with a protective layer, mounted on a dicing sheet, and singulated (e.g., by saw dicing, laser dicing, reactive ion etch dicing, wet etching, or a combination thereof) to form singulated dies on the dicing frame. The protective layer can be removed (e.g., stripped) from the singulated dies and the exposed dicing sheet (e.g., using solvent, reactive ion etching, etc.). The singulated die can be cleaned (e.g., rinsed and dried using spin drying or other processes). The cleaned dies can be configured for subsequent processes. For example, a cleaned die can be further bonded to a prepared surface of another substrate (e.g., comprising a power pad, ground pads, and/or other passive elements configured to transmit power to the bonded die).

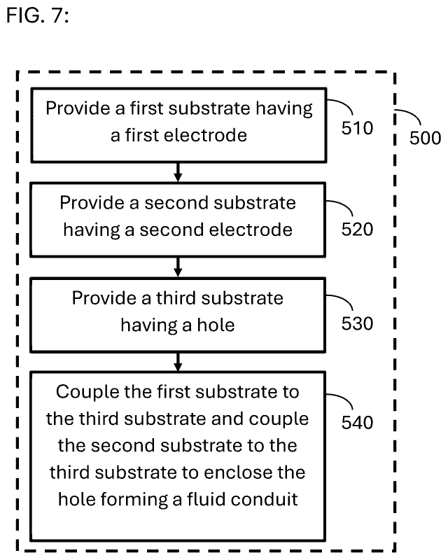

FIG. 7 is a flow diagram of another example method 500 for forming the example structure 200 in accordance with certain implementations described herein. In an operational block 510, the method 500 comprises providing an optically transparent first substrate 210 (e.g., first element 102) having an electrically conductive and optically transparent non-metallic first electrode (e.g., first layer 214) on a first surface 212 of the first substrate 210. For example, the first substrate 210 can comprise an optically transparent and electrically insulative material (e.g., glass; quartz; silica; silicon oxide; polycarbonate; acrylic) and the first electrode can comprise an electrically conductive polymer and/or an electrically conductive oxide. The first electrode can be in electrical communication with an electrical conduit configured to provide electrical voltage and/or current signals to the first electrode. In certain implementations, providing the first substrate 210 comprises forming (e.g., depositing; evaporating; sputtering) the first electrode on the first surface 212.

In an operational block 520, the method 500 further comprises providing a second substrate 220 (e.g., second element 104) having an electrically conductive second electrode (e.g., second layer 224) on a second surface 222 of the second substrate 220. In certain implementations, the second substrate 220 and/or the second electrode is optically opaque, while in certain other implementations, the second substrate 220 and/or the second electrode is optically transparent. For example, the second substrate 220 can comprise an optically transparent and electrically insulative material (e.g., glass; quartz; silica; silicon oxide; polycarbonate; acrylic) and the second electrode can comprise an electrically conductive polymer and/or an electrically conductive oxide. The second electrode can be in electrical communication with an electrical conduit configured to provide electrical voltage and/or current signals to the second electrode. In certain implementations, providing the second substrate 220 comprises forming (e.g., depositing; evaporating; sputtering; 3D printing) the second electrode on the second surface 222.

In an operational block 530, the method 500 further comprises providing a third substrate 260 having a hole 266 (e.g., cavity) extending from a third surface 262 of the third substrate 260 to a fourth surface 264 of the third substrate 260, the fourth surface 264 facing opposite to the third surface 262. The third substrate 260 can be electrically insulative (e.g., e.g., inorganic dielectric material; semiconductor oxide; semiconductor nitride; silicon oxide (SiO₂); silicon nitride (SiNₓ, Si₃N₄); silicon oxycarbonitride (SiOₓN_{y}C_{z}); ceramic; glass; quartz; silica; silicon oxide; polycarbonate; acrylic) and can be optically transparent or optically opaque. The third substrate 260 can comprise the same electrically insulative material as one or both of the first and second substrates 210,220 or the third substrate 260 can comprise a different electrically insulative material from one or both of the first and second substrates 210,220. In certain implementations, providing the third substrate 260 comprises forming the hole 266 (e.g., etched the hole 266 through the third substrate 260).

In an operational block 450, the method 400 further comprises coupling (e.g., bonding) the first substrate 210 to the third substrate 260 and coupling (e.g., bonding) the second substrate 220 to the third substrate 260 such that the first and second surfaces 212,222 at least partially enclose the hole 266 to form a fluid conduit 240 configured to allow a fluid to flow therethrough. The first electrode is electrically isolated from the second electrode (e.g., the first electrode is spaced from the second electrode by a distance in a range of 55 microns to more than 500 microns). The third substrate 260 can be placed between the first substrate 210 and the second substrate 220 with the third surface 262 facing the first surface 212, the fourth surface 264 facing the second surface 222.

For example, coupling the first substrate 210 to the third substrate 260 can comprise using at least a portion of the first electrode as a bonding interface 250a between the first and third substrates 210,260 and/or coupling the second substrate 220 to the third substrate 260 can comprise using at least a portion of the second electrode as a bonding interface 250b between the second and third substrates 220,260. For another example, coupling the first substrate 210 to the third substrate 260 and/or coupling the second substrate 220 to the third substrate 260 can comprise placing an inorganic dielectric material between the two substrates and using the inorganic dielectric material as a bonding interface between the two substrates.

In certain implementations, coupling the first substrate 210 and/or the second substrate 220 to the third substrate 260 is performed without using an adhesive material as a bonding interface between the two substrates. For example, the two substrates can be directly bonded or hybrid bonded to one another. In certain implementations, coupling the first substrate 210 and/or the second substrate 220 to the third substrate 260 comprises activating at least one surface of at least one of the first, second, and third substrates 210,220,260 (e.g., exposing the first, second, third, and/or fourth surface 212,222,262,264 to plasma and/or chemical etchants). The activation can be performed prior to hybrid bonding the substrates with one another. In certain implementations in which the first electrode and/or the second electrode comprises conductive polymer material that facilitates the coupling, coupling the first substrate 210 and/or the second substrate 220 to the third substrate 260 comprises annealing the structure at a temperature higher than the room temperature (e.g., at a temperature in a range of 90° C. to 200° C., such as 110° C.) for an annealing time (e.g., in a range of 10 minutes to 60 minutes) to cause the conductive polymer material to expand and to bond the respective surfaces to one another.

The structure 200 described herein can be configured to be used in a variety of applications that can provide useful fingerprints as diagnostic tools for monitoring reactants in the fluid conduit and the products and byproducts formed by the electric field in the fluid conduit. For example, the structure 200 can be operated in a potentiostatic mode with optical absorption spectroscopy in which a predetermined DC potential is applied to both the first and second electrodes with fluid in the fluid conduit. The DC potential can be varied at a predetermined rate over a predetermined range, and the DC current flowing between the first and second electrodes can be measured while simultaneously collecting the optical spectrum (e.g., absorption; transmittance) of the fluid. For another example, the structure 200 can be operated in a galvanostatic mode with optical absorption spectroscopy in which a predetermined current density is applied to both first and second electrodes with a fluid in the fluid conduit and the voltage output between the first and second electrodes is monitored (e.g., measured). The applied current density can be varied at a predetermined rate over a predetermined range and the DC voltage between the first and second electrodes can be measured while simultaneously collecting the optical spectrum (e.g., absorption; transmittance) of the fluid. For another example, the structure 200 can be operated in a potentiostatic/AC mode with optical absorption spectroscopy in which a predetermined DC potential can be applied to both the first and second electrodes with a predetermined constant AC voltage having a unique frequency and amplitude superimposed over the DC potential. The DC voltage can be varied at a predetermined rate over a predetermined range (e.g., the range including potentials at which a substance is deposited and stripped on the first and/or second electrodes), while simultaneously collecting the optical spectrum (e.g., absorption; transmittance) of the fluid.

Although commonly used terms are used to describe the systems and methods of certain implementations for ease of understanding, these terms are used herein to be interpreted fairly. Although various aspects of the disclosure are described with regard to illustrative examples and implementations, the disclosed examples and implementations should not be construed as limiting. Conditional language, such as, among others, “can,” “could,” “might,” or “may,” unless specifically stated otherwise, or otherwise understood within the context as used, is generally intended to convey that certain implementations include, while other implementations do not include, certain features, elements and/or steps. Thus, such conditional language is not generally intended to imply that features, elements and/or steps are in any way required for one or more implementations or that one or more implementations necessarily include logic for deciding, with or without user input or prompting, whether these features, elements and/or steps are included or are to be performed in any particular implementation. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

It is to be appreciated that the implementations disclosed herein are not mutually exclusive and may be combined with one another in various arrangements. In addition, although the disclosed methods and apparatuses have largely been described in the context of direct bonding processes, various implementations described herein can be incorporated in a variety of other suitable devices, methods, and contexts.

Language of degree, as used herein, such as the terms “approximately,” “about,” “generally,” and “substantially,” represent a value, amount, or characteristic close to the stated value, amount, or characteristic that still performs a desired function or achieves a desired result. For example, the terms “approximately,” “about,” “generally,” and “substantially” may refer to an amount that is within ±10% of, within ±5% of, within ±2% of, within ±1% of, or within ±0.1% of the stated amount. As another example, the terms “generally parallel” and “substantially parallel” refer to a value, amount, or characteristic that departs from exactly parallel by ±10 degrees, by ±5 degrees, by ±2 degrees, by ±1 degree, or by ±0.1 degree, and the terms “generally perpendicular” and “substantially perpendicular” refer to a value, amount, or characteristic that departs from exactly perpendicular by ±10 degrees, by ±5 degrees, by ±2 degrees, by ±1 degree, or by ±0.1 degree. The ranges disclosed herein also encompass any and all overlap, sub-ranges, and combinations thereof. Language such as “up to,” “at least,” “greater than,” less than,“ “between,” and the like includes the number recited. As used herein, the meaning of “a,” “an,” and “said” includes plural reference unless the context clearly dictates otherwise. Also, as used in the description herein, the meaning of “in” includes “into” and “on,” unless the context clearly dictates otherwise.

While the methods and systems are discussed herein in terms of elements labeled by ordinal adjectives (e.g., first, second, etc.), the ordinal adjective are used merely as labels to distinguish one element from another (e.g., one substrate from another or one surface layer from one another), and the ordinal adjective is not used to denote an order of these elements or of their use.

The disclosure described and claimed herein is not to be limited in scope by the specific example implementations herein disclosed, since these implementations are intended as illustrations, and not limitations, of several aspects of the disclosure. Any equivalent implementations are intended to be within the scope of this disclosure. Indeed, various modifications of the disclosure in form and detail, in addition to those shown and described herein, will become apparent to those skilled in the art from the foregoing description. Such modifications are also intended to fall within the scope of the claims. The breadth and scope of the disclosure should not be limited by any of the example implementations disclosed herein, but should be defined only in accordance with the claims and their equivalents.

1. A structure comprising:
an optically transparent first substrate comprising a first surface and at least one first layer on at least a portion of the first surface, the at least one first layer comprising at least one electrically conductive and optically transparent first material;
a second substrate comprising a second surface and at least one second layer on at least a portion of the second surface, the at least one second layer comprising at least one electrically conductive second material, the second surface facing the first surface, at least one of the first and second surfaces comprising at least one recess; and
a fluid conduit between the first and second surfaces, the fluid conduit comprising the at least one recess and configured to allow a fluid flow therethrough, the at least one first layer and the at least one second layer configured to apply an electric voltage and/or current to a fluid within at least a portion of the fluid conduit.

2. The structure of claim 1, wherein the first material comprises an electrically conductive polymer.

3. The structure of claim 2, wherein the electrically conductive polymer comprises an intrinsically electrically conductive polymer selected from the group consisting of: polyacetylene (PA); polyaniline (PANI); poly[3,4-(ethylenedioxy)thiophene] (PEDOT); PEDOT:polystyrene-sulphonate (PEDOT:PSS); polypyrrole (PPy); polythiophene (PT); poly(o-phenylene-diamine) (PoPDA).

4. The structure of claim 1, wherein the first material comprises an electrically conductive oxide.

5. (canceled)

6. The structure of claim 1, wherein the at least one first layer has an optical transmittance greater than 50% and an electrical resistivity lower than 10⁻⁴ ohm—cm.

7. The structure of claim 1, wherein the at least one second layer comprises an optically reflecting material.

8. (canceled)

9. The structure of claim 1, wherein the second substrate is optically transparent and the second material is optically transparent.

10. -12. (canceled)

13. The structure of claim 1, wherein at least a portion of the at least one first layer and/or the at least one second layer at least partially bounds the fluid conduit.

14. The structure of claim 1, wherein the first and second surfaces are affixed to one another.

15. -17. (canceled)

18. The structure of claim 1, further comprising a third substrate comprising a third surface, a fourth surface facing opposite to the third surface, and a hole extending from the third surface to the fourth surface, the third substrate between the first substrate and the second substrate with the third surface facing the first surface, the fourth surface facing the second surface, and the hole aligned with the at least one recess such that the fluid conduit includes the hole.

19. The structure of claim 1, wherein the at least one first layer and/or the at least one second layer further comprises an optically transparent metal layer.

20. (canceled)

21. The structure of claim 1, further comprising an inorganic dielectric layer between the first surface and the second surface, the inorganic dielectric layer configured to bond the first substrate and the second substrate to one another.

22. The structure of claim 1, further comprising a first light source configured to generate a first optical beam and a detector configured to receive a portion of the first optical beam after the portion of the first optical beam propagates through the fluid conduit.

23. (canceled)

24. (canceled)

25. A method comprising:
providing an optically transparent first substrate;
forming a cavity at a first surface of the first substrate;
forming an electrically conductive and optically transparent non-metallic first electrode on an inner wall of the cavity;
providing a second substrate having an electrically conductive second electrode on a second surface of the second substrate; and
coupling the second substrate to the first substrate such that the second surface at least partially encloses the cavity to form a fluid conduit configured to allow a fluid to flow therethrough, the first electrode electrically isolated from the second electrode.

26. The method of claim 25, wherein the first electrode comprises an electrically conductive polymer and/or an electrically conductive oxide.

27. The method of claim 25, wherein the second substrate is optically transparent and the second electrode is optically transparent.

28. (canceled)

29. The method of claim 25, wherein said forming the cavity comprises etching a portion of the first surface.

30. The method of claim 25, wherein said forming the cavity comprises compressing a portion of the first surface.

31. The method of claim 25, wherein said forming the first electrode comprises depositing an electrically conductive and optically transparent non-metallic material over the first surface.

32. The method of claim 25, wherein said providing the second substrate comprises forming the second electrode on the second surface

33. The method of claim 25, wherein said providing the second substrate comprises:
forming a second cavity at the second surface; and
forming the second electrode on an inner wall of the second cavity.

34. The method of claim 25, wherein said coupling the second substrate to the first substrate comprises using at least a portion of the first electrode and/or at least a portion of the second electrode as a bonding interface between the first and second substrates.

35. The method of claim 25, wherein said coupling the second substrate to the first substrate comprises placing an inorganic dielectric material between the first and second substrates and using the inorganic dielectric material as a bonding interface between the first and second substrates.

36. The method of claim 25, wherein said coupling the second substrate to the first substrate is performed without using an adhesive material as a bonding interface between the first and second substrates.

37. (canceled)

38. (canceled)

39. The method of claim 25, further comprising:
providing a third substrate comprising a third surface, a fourth surface facing opposite to the third surface, and a hole extending from the third surface to the fourth surface; and
placing the third substrate between the first substrate and the second substrate with the third surface facing the first surface, the fourth surface facing the second surface, and the hole aligned with the cavity such that the fluid conduit includes the hole.

40.-44. (canceled)

45. A structure comprising:
an optically transparent first substrate comprising a first surface and at least one first layer on at least a portion of the first surface, the at least one first layer comprising at least one electrically conductive and optically transparent first material;
a second substrate comprising a second surface and at least one second layer on at least a portion of the second surface, the at least one second layer comprising at least one electrically conductive second material, the second surface facing the first surface;
a third substrate comprising a third surface, a fourth surface facing opposite to the third surface, and a hole extending from the third surface to the fourth surface, the third substrate between the first substrate and the second substrate with the third surface facing the first surface, the fourth surface facing the second surface; and
a fluid conduit between the first and second surfaces, the fluid conduit comprising the hole and configured to allow a fluid flow therethrough, the at least one first layer and the at least one second layer configured to apply an electric voltage and/or current to a fluid within at least a portion of the fluid conduit.

46.-67. (canceled)

68. A method comprising:
providing an optically transparent first substrate having an electrically conductive and optically transparent non-metallic first electrode on a first surface of the first substrate;
providing a second substrate having an electrically conductive second electrode on a second surface of the second substrate;
providing a third substrate having a cavity extending from a third surface of the third substrate to a fourth surface of the third substrate, the fourth surface facing opposite to the third surface; and
coupling the first substrate to the third substrate and coupling the second substrate to the third substrate such that the first and second surfaces at least partially enclose the cavity to form a fluid conduit configured to allow a fluid to flow therethrough with the first electrode electrically isolated from the second electrode.

69.-80. (canceled)

81. A structure comprising:
an optically transparent first substrate comprising a first surface and at least one first layer on at least a portion of the first surface, the at least one first layer comprising at least one electrically conductive and optically transparent first material; and
a second substrate comprising a second surface and at least one second layer on at least a portion of the second surface, the at least one second layer comprising at least one electrically conductive second material, the second surface facing the first surface, at least one of the first and second surfaces comprising at least one cavity between the first and second surfaces, the cavity configured to allow a fluid flow therethrough, the at least one first layer and the at least one second layer configured to apply an electric voltage and/or current to a fluid within at least a portion of the at least one cavity.

82.-85. (canceled)
